(19) United States
(12) Patent Application Publication
(10) Pub. No.: US 2026/0221928 A1
(43) Pub. Date: Jul. 30, 2026

(54) Mounting System

(71) Applicant: TSKA, LLC, Golden, CO (US)

(72) Inventor: Brian Shamas, Golden, CO (US)

(21) Appl. No.: 19/447,202

(22) Filed: Jan. 13, 2026

Related U.S. Application Data
(60) Provisional application No. 63/751,648, filed on Jan. 30, 2025.
(60) Provisional application No. 63/924,831, filed on Nov. 25, 2025.

(51) Int. Cl. H02S 20/24

(52) U.S. Cl. CPC H02S 20/24

(57) ABSTRACT

A mounting system may include a base plate and a receiver mounted to the base plate. The receiver includes first and second flange members positioned in generally parallel, spaced-apart relation and extending generally upwardly from a top surface of the base plate so that an interior cavity is defined therebetween, the interior cavity of the receiver being sized to receive a mounting bracket for mounting a piece of equipment to the mounting system. A spring fastener assembly operably engagable with a fastener opening defined by the mounting bracket and a fastener opening defined by the first and second flange members secures the mounting bracket to the receiver.

### CROSS-REFERENCE TO RELATED APPLICATIONS

This application claims the benefit of U.S. Provisional Patent Application No. 63/924,831, filed on Nov. 25, 2025, and U.S. Provisional Patent Application No. 63/751,648, filed on Jan. 30, 2025, both of which are hereby incorporated herein by reference for all that they disclose.

### TECHNICAL FIELD

The disclosed instrumentalities relate to mounting systems in general and more specifically to mounting systems for mounting equipment to building roofs or other structures.

### BACKGROUND

Numerous types of mounting systems for securing equipment, such as solar panel systems, to roofs of buildings are known in the art. While functional for their intended purpose, such mounting systems often require specialized skills and careful attention to placement to ensure the mounting system is mounted to the building at the appropriate location and to ensure long-term water-tight integrity. Consequently, a need remains for a mounting system that does not require specialized skills and that provides for increased dimensional adjustability and long-term water-tight integrity.

### SUMMARY

One embodiment of a mounting system according to the disclosed instrumentalities may include a base plate and a receiver mounted to the base plate. The receiver may include at least first and second sidewalls that extend upwardly from the base plate in generally parallel, spaced-apart relation so that an interior cavity is defined therebetween. A mounting bracket having a bottom portion and first and second leg portions extending from the bottom portion in generally parallel-spaced apart relation is sized to be received by the interior cavity defined by the receiver. A spring fastener assembly operably engagable with a fastener openings defined by the first and second sidewalls of the receiver and the first and second leg portions of the mounting bracket secures the mounting bracket to the receiver.

Also disclosed is a method of mounting equipment to a support structure that includes the steps of: Providing a mounting system having the base plate, receiver, mounting bracket, and spring fastener assembly; providing a sealing membrane, the sealing membrane defining a central aperture therein sized to receive the receiver and an outer periphery that extends beyond a plurality of mounting holes defined by the base plate; mounting the base plate to the support structure with a plurality of mounting fasteners; positioning the sealing membrane over the top surface of the base plate; sealingly engaging the outer periphery of the sealing membrane to the support structure; positioning the mounting bracket within the interior cavity defined by the receiver; engaging the spring fastener assembly loosely with the receiver and the mounting bracket so that the mounting bracket is moveable with respect to the receiver; securing the mounting bracket to at least a portion of the equipment; and tightening the spring fastener assembly so that the mounting bracket is not moveable with respect to said mounting system.

In another embodiment of a mounting system according to the disclosed instrumentalities may include a base plate and a receiver mounted to the base plate. The receiver may include first and second flange members positioned in generally parallel, spaced-apart relation and extending generally upwardly from the top surface of the base plate so that an interior cavity is defined therebetween, the interior cavity of the receiver being sized to receive a mounting bracket for mounting a piece of equipment to the mounting system. A spring fastener assembly is operably engagable with a fastener opening defined by the mounting bracket and a fastener opening defined by the first and second flange members.

Another method of mounting equipment to a support structure may involve: Providing a mounting system having the base plate and receiver; providing a mounting bracket sized to be received by and interior cavity defined by the receiver, the mounting bracket defining at least one fastener opening therein; providing a spring fastener assembly operably engagable with the fastener opening defined by the mounting bracket and fastener opening defined by the first and second flange members; providing a sealing membrane, the sealing membrane defining a central aperture therein sized to receive the receiver and an outer periphery that extends beyond a plurality of mounting holes defined by the base plate; mounting the base plate to the support structure with a plurality of mounting fasteners, each of the plurality of mounting fasteners engaging corresponding ones of the plurality of holes defined by the base plate and the support structure; positioning the sealing membrane over the top surface of the base plate; sealingly engaging the outer periphery 4 the sealing membrane to the support structure; positioning the mounting bracket within the interior cavity defined by the receiver; engaging the spring fastener assembly loosely with the receiver and the mounting bracket so that the mounting bracket is moveable with respect to the receiver; securing the mounting bracket to at least a portion of the equipment; and tightening the spring fastener assembly so that the mounting bracket is not moveable with respect to said mounting system.

### BRIEF DESCRIPTION OF THE DRAWINGS

Illustrative and presently preferred exemplary embodiments of the disclosed instrumentalities are shown in the drawings in which:

FIG. 1 is a perspective view of an embodiment of a mounting system according to the disclosed instrumentalities showing an assembled configuration of a base plate, mounting bracket, and a first embodiment of a spring nut assembly;

FIG. 2 is a cross-sectional end view in elevation of the mounting system illustrated in FIG. 1 shown mounted to an example support structure;

FIG. 3 is a plan view of one embodiment of a sealing membrane according to the disclosed instrumentalities;

FIG. 4 is a top view of the mounting system illustrated in FIG. 1;

FIG. 5 is a side view in elevation of the mounting system illustrated in FIG. 1;

FIG. 6 is an exploded perspective view of the mounting system illustrated in FIG. 1 more clearly showing the components of the first embodiment of the spring nut assembly;

FIG. 7 is an enlarged perspective view of the first embodiment of the spring nut assembly in the assembled position;

FIG. 8 is an enlarged top view of the first embodiment of the spring nut assembly illustrated in FIG. 7;

FIG. 9 is an enlarged exploded perspective view of the first embodiment of the spring nut assembly illustrated in FIG. 7;

FIG. 10 is a perspective view of another embodiment of a spring nut assembly wherein the spring member is attached to the nuts;

FIG. 11 is an exploded perspective view of another embodiment of a mounting system according to the disclosed instrumentalities having a second embodiment of a spring nut assembly;

FIG. 12 is a perspective view of yet another embodiment of a mounting system according to the disclosed instrumentalities showing an assembled configuration of a base plate and snow retention bar bracket with the mounting bracket and spring nut assemblies removed for clarity;

FIG. 13 is a side view in elevation of a spring fastener assembly having a coil-less spring member;

FIG. 14 is a side view in elevation of a spring fastener assembly having a coiled spring member; and

FIG. 15 is a side view in elevation of a spring fastener assembly having a sleeve and plunger spring member.

### DETAILED DESCRIPTION OF THE PREFERRED EMBODIMENTS

The following is a description of exemplary embodiments that illustrate the principles of the disclosed instrumentalities. While the embodiments illustrate various aspects of the disclosed instrumentalities, the disclosed instrumentalities should not be regarded as limited to any particular embodiment or combination of features from among the embodiments. The scope of the disclosed instrumentalities encompasses numerous alternatives, modifications and equivalents.

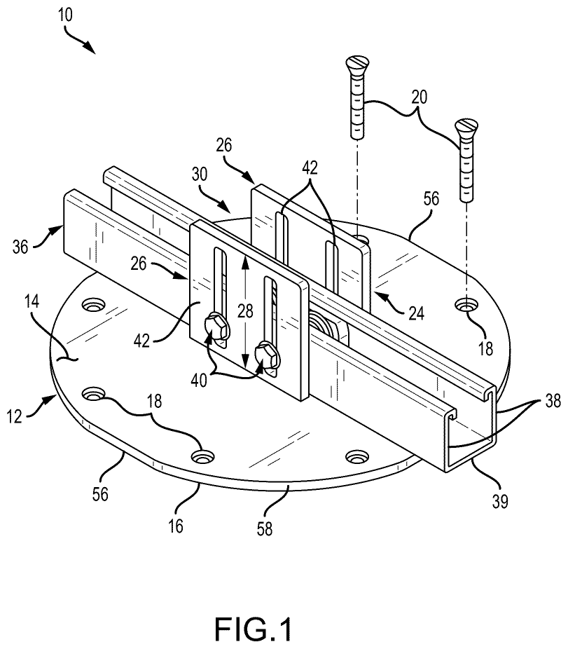

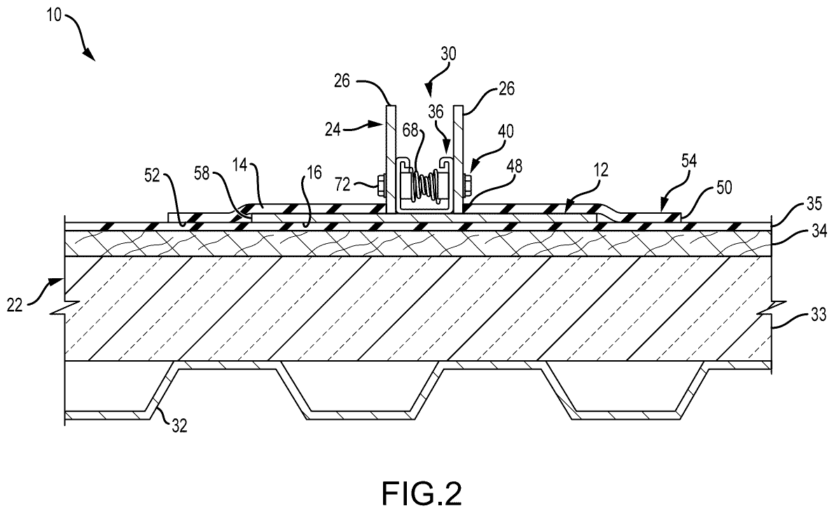

Briefly described, and with reference primarily to FIGS. 1-3, one embodiment of a mounting system 10 may comprise a base plate 12 having a top surface 14 and a bottom surface 16. Base plate 12 may define a plurality of mounting holes 18 therein sized to receive a plurality of mounting fasteners 20, two of which are illustrated in FIG. 1. As will be described in further detail below, mounting fasteners 20 may be used to secure base plate 12 to a support structure 22 (FIG. 2), such as a portion of a building roof.

Mounting system 10 may also include a receiver 24 mounted to base plate 12. Receiver 24 may include first and second sidewalls or flange members 26 that extend upwardly from top surface 14 of base plate 12. Taken together, sidewalls or flange members 26 define a height 28 of receiver 24. Sidewalls or flange members 26 also define an interior cavity 30 of receiver 24. Interior cavity 30 is sized to receive a mounting bracket 36, which in turn may be configured to receive or mount equipment (not shown) to be mounted to support structure 22. In the particular embodiments shown and described herein, mounting bracket 36 may comprise a generally elongate, U-shaped member having a pair of leg portions or members 38 that are joined together by a bottom portion 39. Alternatively, other configurations of mounting bracket 36 are possible and may be used instead.

Mounting system 10 may also comprise one or more spring fastener assemblies 40. As will be described in much greater detail below, one or more spring fastener assemblies 40 may be used to secure mounting bracket 36 to receiver 24. For example, and in the particular embodiments shown and described herein, mounting bracket 36 may be secured or mounted within interior cavity 30 of receiver 24. Alternatively, and in other embodiments, mounting bracket 36 may be secured to receiver 24 outside of interior cavity 30, i.e., alongside receiver 24.

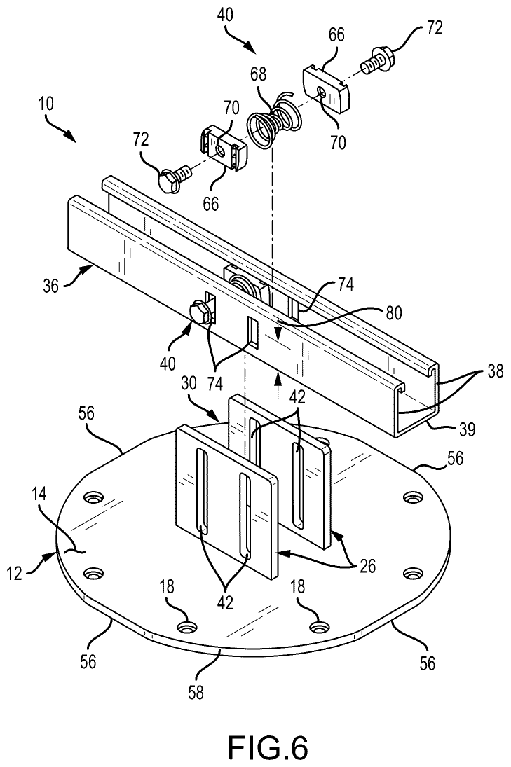

More specifically, spring fastener assemblies 40 are sized to be received by fastener openings 42 defined by first and second side walls or flanges 26 of receiver 24. Spring fastener assemblies 40 are also sized to be received by fastener openings 74 provided in mounting bracket 36. See also FIG. 6. As will be described in greater detail below, the engagement of spring fastener assemblies 40 with fastener holes 42 and 74 is such that mounting bracket 36 is moveable with respect to receiver 24 when spring fastener assemblies 40 are in a loosened position. However, mounting bracket 36 is not moveable with respect to receiver 24 when spring fastener assemblies 40 are in a tightened position.

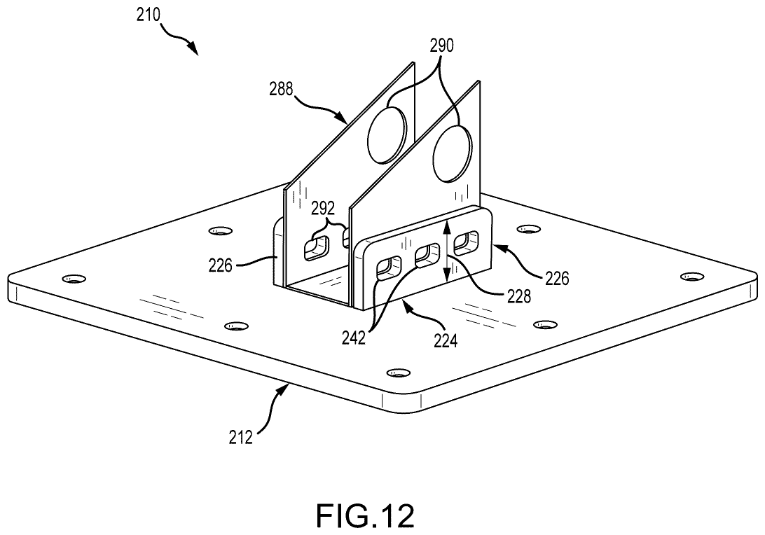

For example, in some embodiments mounting bracket 36 is moveable with respect to receiver 24 primarily along the height 28 of receiver 24 when spring fastener assemblies 40 are in the loosened position. This relative movement allows mounting bracket 36 to be secured at various heights or elevations with respect to base plate 12, thereby providing the desired elevation or alignment of the equipment (not shown) with respect to base plate 12 and support structure 22. In other embodiments, such as that illustrated in FIG. 12, mounting bracket 36 may be movable with respect to receiver 24 primarily along a horizontal direction when spring fastener assemblies 40 are in the loosened position.

In any event and with reference back now primarily to FIGS. 1-3, mounting system 10 may also include a sealing membrane 54. Sealing membrane 54 defines a central aperture 48 therein that is sized to receive or accommodate receiver 24 (i.e., defined by first and second flange members 26). An outer periphery 50 of sealing membrane 54 is sized to extend beyond outer periphery 58 of base plate 12 when sealing membrane 54 is positioned adjacent top surface 14 of base plate 12, as best seen in FIG. 2. Sealing membrane 54 may be provided with an adhesive/sealant (not specifically shown) on a back surface 52 thereof to allow sealing membrane 54 to be adhered to and sealingly engaged with base plate 12 and support structure 22. Sealing membrane 54 thereby prevents the ingress of moisture (e.g., water) between base plate 12 and support structure 22. By overlying mounting holes 18 and corresponding mounting fasteners 20, sealing membrane 54 also prevents the ingress of moisture between mounting fasteners 20, mounting holes 18, and thence into support structure 22.

Mounting system 10 may be used as follows to mount equipment, such as a solar panel system (not shown) to support structure 22, such as a building roof. A first step in the process involves providing a mounting system 10 substantially as shown and described herein. Base plate 12 may be mounted to support structure 22 at the desired location via mounting fasteners 20. Then, sealing membrane 54 may be positioned over base plate 12 so that back surface 52 of sealing membrane 54 contacts top surface 14 of base plate 12. The portion of outer periphery 50 of sealing membrane 54 that extends beyond outer periphery 58 of base plate 12 then may be placed in contact with support structure 22. Sealing membrane 54 may then be adhered and/or sealingly engaged with at least support structure 22 and also generally with top surface 14 of base plate 12. If sealing membrane 54 is adhesive-backed, then the sealing engagement may be accomplished by applying the appropriate pressure to sealing membrane 54. Alternatively, if a separate adhesive/sealant is used, then such a separate adhesive/sealant may be applied first, i.e., before positioning sealing membrane 54 on base plate 12 and support structure 22. The adhesive/sealant may be applied to either one or both of back surface 52 of sealing membrane 54, top surface 14 of base plate 12, and support structure 22, as may be desired or required for the particular materials and adhesives/sealants involved.

Once base plate 12 has been mounted to support structure 22 and sealing membrane 54 applied, mounting bracket 36 may be positioned within interior cavity 30 of receiver 24. One or more spring fastener assemblies 40 may then loosely engaged (i.e., provided in the loosened position) with mounting bracket 36 and flange members 26 of receiver 24 so that mounting bracket 36 is moveable with respect to receiver 24, e.g., primarily along height direction 28. If desired, mounting bracket 36 then may be mounted to at least a portion of the equipment (not shown). The loose engagement of mounting bracket 36 with receiver 24 allows for a certain amount of relative movement (e.g., in the height direction 28) between mounting bracket 36 and base plate 12, thereby easing the mounting process and preventing undesirable loads (e. g., side loads or bending moments) from being applied to mounting system 10. Thereafter, spring fastener assembly 40 may be tightened to secure mounting bracket 36 within receiver 24 at the desired position.

One advantage of the mounting system according to the disclosed instrumentalities is that mounting system 10 may be more easily and quickly installed compared to many known mounting systems. For example, after base plate 12 is mounted to support structure 22, the mounting system 10 may be sealed to support structure 22 by simply positioning an adhering sealing membrane 54 over top surface 14 of base plate 12 and to the outer surface (e.g., membrane 35) of support structure 22. Moreover, depending on the particular material used for sealing membrane 54 and/or the adhesive used to secure sealing membrane 54 to support structure 22, special skills and equipment are typically not required to achieve a reliable and long-lasting watertight seal. Sealing membrane 54 covers the heads of fasteners 20, therefore preventing water or moisture from seeping or wicking down fasteners 20 into support structure 22. Moreover, the fact that outer periphery 50 of sealing membrane 54 extends beyond outer periphery 58 of base plate 12 provides for an additional large sealing area to prevent water or moisture from seeping or wicking into the interface between bottom surface 16 of base plate 12 and support structure 22 (e.g., membrane 35 of support structure 22).

Still other advantages are associated with spring nut assemblies 40. For example, spring nut assemblies 40 may be positioned within mounting bracket 36 in advance of assembly, thereby dispensing with the need for the spring nut assemblies 40 to be installed while also holding mounting bracket 36 within interior cavity 30 of receiver 24. Then, when located at the desired position within cavity 30, the installer may simply thread fasteners 72 into the nuts 66. When spring nut assemblies 40 are in the loosened position, the installer may easily move and/or reposition mounting bracket 36 with respect to receiver 24. Then, when mounting bracket 36 is in the desired position, the installer may simply tighten fasteners 72 to secure mounting bracket 36 to receiver 24 of base plate 12, all without the need for the installer to use a wrench or other tool to prevent nuts 66 from turning within mounting bracket 36.

Still yet other advantages are associated with the increased dimensional adjustability provided by the disclosed instrumentalities. For example, the increased dimensional adjustability of the mounting system 10 more easily accommodates differences in roof height and minor variations in slopes or slope changes, as may be used to improve drainage, particularly in so-called ‘flat’ roofs, which are not planar. The disclosed instrumentalities also increase the surface area of the mounting ‘plate’ on the roof or other such structure and equipment connection, thereby increasing the resistance to forces and loads exerted on the equipment from wind loads, snow loads, vibrations, thermal expansion, etc.

Having briefly described one embodiment of the mounting system according to the disclosed instrumentalities, as well as some of its more significant features and advantages, various embodiments and alternative arrangements of the mounting system will now be described in detail. However, before proceeding with the description, it should be noted that while the various embodiments of the mounting system are shown and described herein as they could be used to mount photovoltaic panels on a building roof, the disclosed instrumentalities could be used to mount any of a wide variety of equipment on any of a wide variety of support structures, as would become apparent to persons having ordinary skill in the art after having become familiar with the teachings described herein. Consequently, the disclosed instrumentalities should not be regarded as limited to the particular equipment, support structures, configurations, and applications shown and described herein.

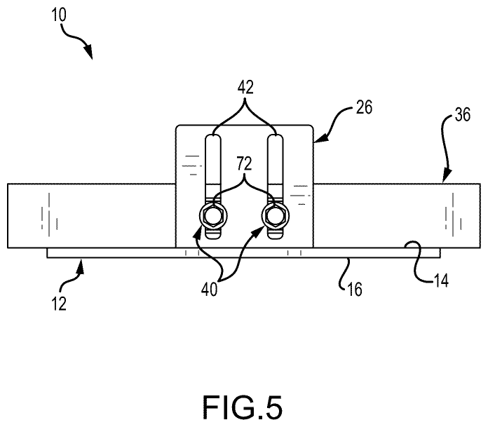

With reference back now primarily to FIGS. 1-6, one embodiment of a mounting system 10 may comprise a base plate 12 having a top surface 14 and a bottom surface 16. In some embodiments, base plate 12 may comprise a substantially circular configuration or planform having a generally circularly-shaped outer periphery 58. In the particular embodiments shown and described herein, outer periphery 58 of base plate 12 may be provided with flattened sections 56 located at substantially diametrically opposed positions, although the provision of flattened sections 56 is not required. Alternatively, and as will be described in further detail below, base plate 12 may comprise a rectangular or square configuration, such as that illustrated in FIG. 12 for base plate 212 of mounting system embodiment 210. Still other shapes or configurations are possible, as would become apparent to persons having ordinary skill in the art after having become familiar with the teachings provided herein. Consequently, the disclosed instrumentalities should not be regarded as limited to base plates having any particular shape or configuration.

Base plate 12 may comprise any of a wide range of sizes suitable for the particular application, support structure, expected equipment loads, and other factors, as would become apparent to persons having ordinary skill in the art after having become familiar with the teachings provided herein. Consequently, the disclosed instrumentalities should not be regarded as limited to a base plate 12 having any particular size. However, by way of example, a base plate 12 having a circular configuration may have an overall diameter of about 26 cm (about 10.25 inches) and a distance of about 25.4 cm (about 10 inches) between diametrically-opposed flattened sections 56. A base plate 212 having a rectangular or square configuration (e.g., as illustrated in FIG. 12) may have a length of about 29.2 cm (about 11. 5 inches) on each side. Base plates 12, 112 may be provided with any of a wide range of thicknesses depending on the particular application, strength or loading requirements, and material used to fabricate base plate 12, 112.

As briefly described above, base plate 12 also may define a plurality of mounting holes 18 therein sized to receive a plurality of mounting fasteners 20. Mounting fasteners 20 may be used to secure base plate 12 to a support structure 22, such as a portion of a building roof. Mounting fasteners 20 may comprise any of a wide range of fasteners now known in the art or that may be developed in the future that are, or would be, suitable for this purpose.

For example, and in the particular embodiments shown and described herein, support structure 22 may comprise a flat building roof having a layered or laminated structure provided atop a corrugated support deck 32. The layered or laminated structure may include an insulation layer 33 surmounted by a cover material 34. A suitable membrane material 35 may be affixed over cover material 34 to prevent water from contacting cover material 34 and/or otherwise seeping into laminated structure comprising support structure 22. Accordingly, mounting fasteners 20 may comprise screws, bolts, or combinations thereof of sufficient length and thread configuration to engage support structure 22 and securely attach base plate 12 to support structure 22.

As was briefly described above, mounting system 10 may also include a receiver 24 mounted to base plate 12. In the particular embodiments shown and described herein, receiver 24 may be defined by first and second upstanding sidewalls or flange members 26 provided in generally parallel, spaced apart relation. Flange members 26 extend generally upwardly from top surface 14 of base plate 12 and together define a height 28 of receiver 24. First and second sidewalls or flange members 26 also define an interior cavity 30 of receiver 24 sized to receive mounting bracket 36.

The height 28 defined by first and second sidewalls or flange members 26 and 27 may be selected to be any of a wide range of heights depending on the particular application, support structure 22, mounting bracket 36, equipment desired to be mounted to support structure 22 and other factors. By way of example, in the embodiments illustrated in FIGS. 1-6 and 9, first and second flange members 26 may define a standard or “high-profile” receiver 24, having a height of about 8 cm (about 3.125 inches) and a length of about 8.9 cm (about 3.5 inches). Alternatively, in another embodiment 210 illustrated in FIG. 12, first and second flange members 226 may define a “low-profile” receiver 224. The height 228 of low-profile receiver 224 may be about 3.6 cm (about 1.4 inches) and a length of about 8.9 cm (about 3.5 inches). Alternatively, of course, other heights 28, 228, and lengths may be used, as would become apparent to persons having ordinary skill in the art after having become familiar with the teachings provided herein. Consequently, the disclosed instrumentalities should not be regarded as limited to receivers having any particular heights and lengths. Flange members 26, 226 may be provided with any of a wide range of thicknesses depending on the particular application, strength or loading requirements, and material used to fabricate flange members 26, 226.

As briefly mentioned earlier, each flange member 26 may define one or more fastener openings or holes 42 therein sized to engage spring fastener assemblies 40. It is generally preferred, but not required, that each fastener opening 42 comprise an elongate opening or slot to allow mounting bracket 36 to be moved with respect to receiver 24 when spring fastener assemblies 40 are in the loosened position, as best seen in FIGS. 1, 5, and 6. In the particular embodiments shown in FIGS. 1, 2, 4-6, and 11, fastener openings 40 defined by first and second flange members 26 may define two such elongate slots, oriented so that they are generally parallel to height direction 28. Alternatively, in other embodiments, such as that illustrated in FIG. 12 having a low-profile receiver 224, first and second sidewalls or flange members 226 may define three such elongate slots 242, as best seen in FIG. 12. Elongate slots 242 illustrated in FIG. 12 for low-profile receiver 224 may be oriented so that they are generally horizontally-oriented (i.e., generally perpendicular to height 228 of receiver 224). Such horizontally-oriented elongate slots 242 still allow relative movement between mounting bracket (not shown in FIG. 12) and base plate 212, but primarily in the longitudinal or horizontal direction, rather than in the height or vertical direction.

Base plate 12 and receiver 24 may be fabricated from any of a wide range of materials, such as metals, metal alloys, polymer plastics, and reinforced polymer plastics now known in the art or that may be developed in the future that are (or would be) suitable for the particular application, support structure, and expected equipment loads. Consequently, the disclosed instrumentalities should not be regarded as limited to any particular materials. However, by way of example, in one embodiment, base plate 12 and receiver 24 are formed from type 6062 aluminum alloy.

In this regard it should be noted that base plate 12 and receiver 24 may be formed from two separate pieces of material that are then fastened together, e.g., by welding or riveting. Alternatively, base plate 12 and receiver 24 could be formed as a single piece (e.g., by casting, forging, or molding). In embodiments wherein first and second sidewalls or flange members 26 comprise separate members, base plate 12 may define one or more openings or slots (not shown) therein sized to receive corresponding pins or tabs (also not shown) provided on first and second sidewalls 26. The engagement of tabs on first and second sidewalls 26 with respective slots defined by base plate 12 position and locate first and second sidewalls 26 in generally parallel, spaced-apart relation on base plate 12. Once properly located, first and second flanges 26 may be fixedly secured to base plate 12, e.g., by welding.

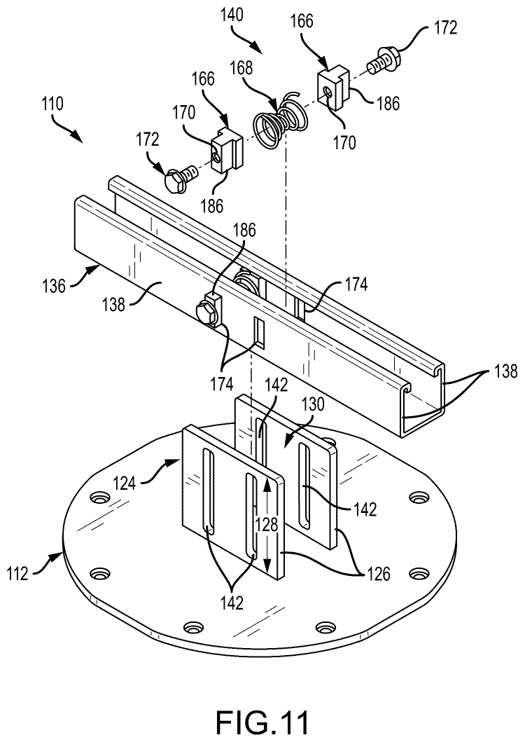

As briefly mentioned above, interior cavity 30 defined by receiver 24 may be sized to receive mounting bracket 36. Mounting bracket 36 may be configured to engage at least a portion of equipment (not shown) to be secured to support structure 22 by mounting system 10. In the particular embodiments shown and described herein, mounting bracket 36 may comprise a generally elongate member or ‘track’ having a U-shaped cross-section defined by a pair of leg portions or members 38 joined together by a bottom portion 39. The leg portions or members 38 of mounting bracket 36 also define a plurality of fastener openings 74 therein that are sized to receive spring fastener assemblies 40. In the particular embodiments shown and described herein, fastener openings 74 defined by leg members 38 of mounting bracket 36 comprise elongate slots, as best seen in FIG. 6. As will be described in further detail herein, in some embodiments, the elongate slots comprising fastener openings 74 provide additional relative movement (i.e., when spring fasteners 40 are in the loosened position) of mounting bracket 36 with respect to receiver 24. In other embodiments, such as those having alternate embodiments of spring fastener assemblies 140 (illustrated in FIG. 11), elongate slots 74 may be sized to engage bosses 176 provided on nuts 166 of spring fastener assemblies 140.

Mounting bracket 36 may be fabricated from any of a wide range of materials, such as metals, metal alloys, polymer plastics, or reinforced polymer plastics that are now known in the art or that may be developed in the future that are or would be suitable for the particular application. Consequently the disclosed instrumentalities should not be regarded as limited to mounting brackets 36 fabricated from any particular material. However, by way of example, in one embodiment, mounting bracket 36 is fabricated from galvanized steel.

Mounting system 10 may also comprise one or more spring fastener assemblies 40. As briefly described above, spring fastener assemblies 40 may be used to secure mounting bracket 36 to base plate 12. In the particular embodiments shown and described herein, each spring fastener 40 is structured and arranged to engage the fastener openings 42 and 74 defined by receiver 24 and mounting bracket 36, respectively. The engagement of spring fastener(s) 40 with receiver 24 and mounting bracket 36 is such that mounting bracket 36 is moveable with respect to receiver 24 when spring fastener(s) 40 is in a loosened position. However, mounting bracket 36 is not moveable with respect to receiver 24 when spring fastener(s) 40 is in a tightened position. For example, in some embodiments, when spring fastener(s) 40 is in the loosened position, mounting bracket 36 is moveable with respect to receiver 24, e. g., primarily along the height 28 of receiver 24. This relative movement allows mounting bracket 36 to be secured at various heights with respect to base plate 12 to provide the desired elevation of the equipment (not shown) with respect to base plate 12.

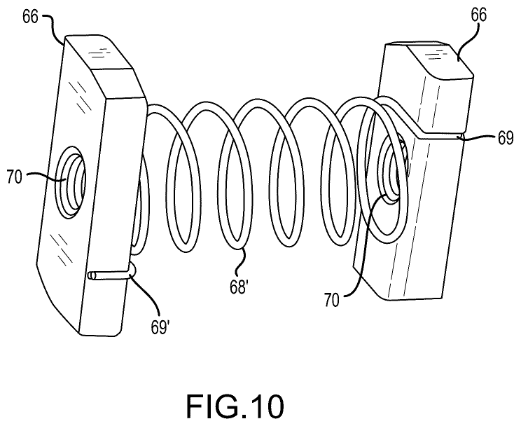

Referring now primarily to FIGS. 6-9, each spring fastener assembly 40 may comprise a pair of nuts 66 between which is provided a spring 68. Spring 68 biases nuts 66 away from one another, i.e., outwardly. In some embodiments, spring 68 may be fixedly attached to nuts 66, although this is not required. For example, in an alternate embodiment illustrated in FIG. 10, spring 68′ may be provided with tangs 69 on either end. In some embodiments, tangs 69 may be received by corresponding slots provided in nuts 66, although the provision of slots is not required. Tangs 69 may be attached to nuts 66 by any convenient means, such as by spot welding or by staking (e.g., in corresponding slots provided in nuts 66).

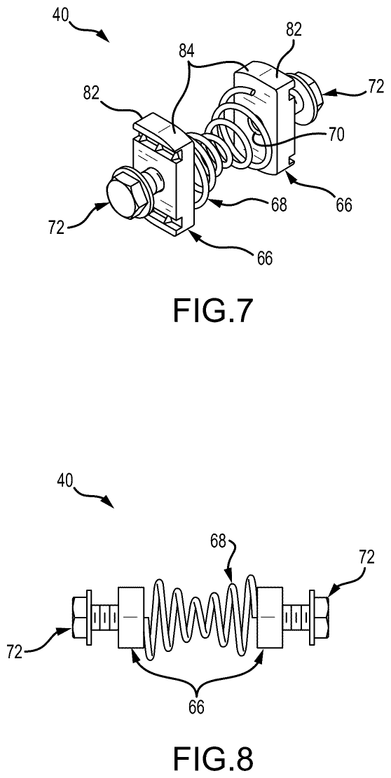

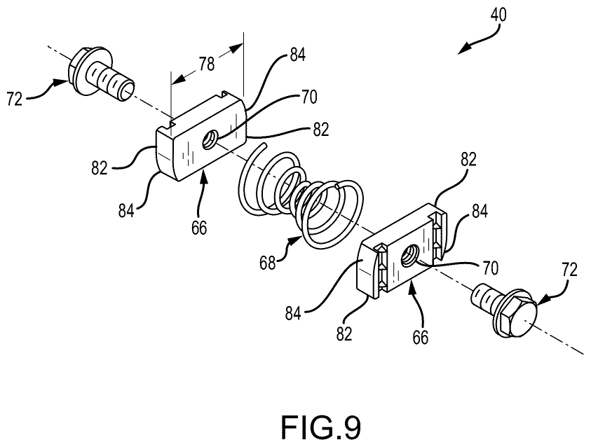

In any event, each nut 66 defines a threaded opening 70 therein that is sized to receive a threaded fastener 72, such as a bolt or screw. In some embodiments, each nut 66 may be prevented from rotating within mounting bracket 36 (e.g., when loosening or tightening bolts 72) by providing each nut 66 with a generally rectangularly-shaped configuration having a length 78 that is greater than a distance 80 between the fastener opening 74 and bottom portion 39 of mounting bracket 36. See FIGS. 6, 7, and 9. In such an embodiment, the rectangularly-shaped nuts 66 will contact the bottom portion 39 of mounting bracket 36 when the threaded fasteners 72 are threaded into nuts 66. The contact between the nuts 66 and the bottom portion 39 of mounting bracket 36 prevents rotation of nuts 66, during either the tightening or loosening process. That is, nuts 66 comprise ‘cam lock’ nuts, wherein the shape of the nut (e.g., a cam configuration) causes the nut to contact mounting bracket 36 in such a way as to prevent nuts 66 from rotating when fasteners 72 are tightened or loosened. If desired, the end portions 82 of each nut 66 may be provided with beveled portions 84 to provide increased contact area between nut 66 and bottom portion 39 of mounting bracket 36, as best seen in FIGS. 7 and 9.

So configured and arranged, each spring fastener 40 may be ‘captured’ or retained in position between legs 38 of mounting bracket 36 before mounting bracket 36 is ever secured to receiver 24 of base plate 12. More specifically, each spring fastener 40 may be positioned between leg members 38 of mounting bracket 36 by pushing together nuts 66 and compressing spring 68. When released, spring 68 extends slot nuts 66 outwardly, causing them to ‘snap’ into position between leg members 38 of mounting bracket 36, all without the need to engage the threaded fasteners 72 in nuts 66.

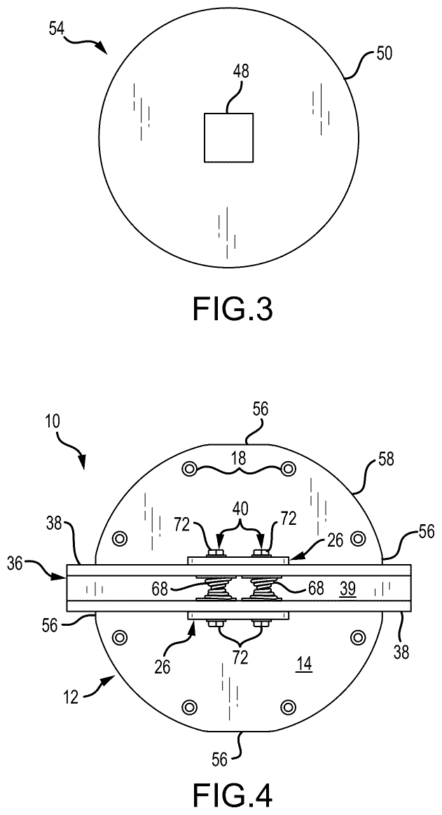

As briefly mentioned earlier, and with reference back now to FIGS. 2 and 3, mounting system 10 may also include a sealing membrane 54. Sealing membrane 54 defines a central aperture 48 therein sized to receive receiver 24. An outer periphery 50 of sealing membrane 54 is sized to extend beyond outer periphery 58 of base plate 12 when sealing membrane is positioned adjacent top surface 14 of base plate 12. Sealing membrane 54 will thus overlay mounting holes 18 and corresponding mounting fasteners 20, thereby preventing the ingress of moisture between mounting fasteners 20, mounting holes 18, and thence into substrate 22.

Sealing membrane 54 may be fabricated from any of a wide range of elastomeric materials, such as TPO, PVC, EPDM, and SBS/BUR, that are now known in the art or that may be developed in the future that would allow sealing membrane 54 to conform to base plate 12 and substrate 22 and prevent the ingress of moisture in the manner described herein. A suitable adhesive/sealant may be provided on back surface 52 of sealing membrane 54 (i.e., as an adhesive backed membrane) or may be separately provided. However, because adhesives/sealants suitable for adhering and sealing membranes to substrates 22 are well-known in the art and could be readily provided by persons having ordinary skill in the art, the particular adhesive/sealant material that may be used in conjunction with the disclosed instrumentalities will not be described in further detail herein.

In other embodiments, sealing membrane 54 may comprise any of a wide range of liquid membrane systems, such as, for example, STPE, PMMA, PUMA, and polyester resin systems. Other liquid membrane systems include, but are not limited to, silicone, modified bitumen, and acrylic resin systems. If a liquid membrane system is used, sealing membrane 54 may be formed over base plate 12 and adjacent portions support structure 22 (e.g., membrane 35) after base plate 12 has been mounted to support structure 22. A suitable template or material dam (not shown) may be provided around base plate 12 to confine liquid membrane system within the desired area of support structure 22 during the forming process.

Mounting system 10 may be used as follows to mount equipment, such as a solar panel system (not shown) to substrate 22, e.g., a building roof. A first step in the process may involve providing a mounting system 10 substantially as shown and described herein. Each base plate 12 may be mounted to support structure 22 at the desired location via mounting fasteners 20. Then, sealing membrane 54 may be positioned over base plate 12 so that back surface 52 of sealing membrane 54 contacts top surface 14 of base plate 12. The portion of outer periphery 50 of sealing membrane 54 then may be placed in contact with support structure 22, i.e., beyond outer periphery 58 of base plate 12. See FIG. 2. Sealing membrane 54 may then be adhered and/or sealingly engaged with at least support structure 22 and also generally with top surface 14 of base plate 12. If sealing membrane 54 is adhesive-backed, then the sealing engagement may be accomplished by applying the appropriate pressure to sealing membrane 54. Alternatively, if a separate adhesive/sealant is used, then such a separate adhesive/sealant may be applied first, i.e., before positioning sealing membrane 54 on base plate 12 and support structure 22. The adhesive/sealant may be applied to either one or both of back surface 52 of sealing membrane 54, top surface 14 of base plate 12, and support structure 22, as may be desired or required for the particular materials and adhesives/sealants involved.

In embodiments wherein sealing membrane 54 comprises liquid membrane system, sealing membrane 54 may be formed over base plate 12 and adjacent portions support structure 22 (e.g., membrane 35) after base plate 12 has been mounted to support structure 22. Again, a suitable template or material dam (not shown) may be provided around base plate 12 to confine liquid membrane system within the desired area of support structure 22 during the forming process.

Once base plate 12 has been mounted to support structure 22 and sealing membrane 54 applied, mounting bracket 36 may be positioned within interior cavity 30 of receiver 24. At this time or before, spring fasteners 40 may be captured or retained between legs 38 of mounting bracket 36 by pushing together nuts 66 to compress spring 68. After being positioned at the desired location within mounting bracket 36, e.g., so that spring fasteners 40 are generally aligned with fastener openings 74 (although this is not immediately required), the compressed spring fastener assembly 40 may be released. When released, spring 68 extends nuts 66 outwardly, causing them to ‘snap’ into position between legs 38 of mounting bracket 36.

Once mounting bracket 36 has been located at the desired position with respect to base plate 12, e.g., within interior cavity 30 defined by receiver 24, fasteners 72 may then be inserted through fastener openings 42 and 74 and threaded into nuts 66. When fasteners 72 are in the loosened position (i.e., not tightened within nuts 66), mounting bracket 36 is moveable with respect to receiver 24, e.g., primarily along height direction 28. Thereafter, mounting bracket 36 may be mounted to at least a portion of the equipment (not shown). The loose engagement of mounting bracket 36 with receiver 24 allows for a certain amount of relative movement between mounting bracket 36 and base plate 12, thereby easing the mounting process and preventing undesirable loads (e.g., side loads or bending moments) from being applied to mounting system 10. Thereafter, fasteners 72 of spring fastener assembly 40 may be tightened to secure mounting bracket 36 to receiver 24 at the desired position.

Other embodiments of spring fastener assemblies are possible. For example, and with reference now to FIG. 11, another embodiment of mounting system 110 may comprise a second embodiment 140 of spring fastener assembly 140. Spring fastener assembly 140 comprises slot nuts 166 that are configured to engage at least fastener openings 174 defined by leg members 138 of mounting bracket 136. In the particular embodiment shown in FIG. 11, slot nuts 166 also engage slots 142 defined by flange members 126 of base plate 112. The engagement of slot nuts 166 with fastener openings 174 prevents the rotation of slot nuts 166 during tightening and loosening of spring fastener assembly 140. However, and in addition, the engagement of slot nuts 166 with fastener openings 142 allows for the convenient retention of mounting bracket 136 between flanges 126 of base plate 112 without the need to insert threaded fasteners 172 in slot nuts 166.

More specifically, each fastener opening 174 defined by leg members 138 of mounting bracket 136 define elongate slots. Each slot nut 166 is provided with a boss 186 thereon that is sized to be received by slots 174. As was the case for spring fastener assembly 40, spring fastener assembly 140 may also include a spring member 168 positioned between slot nuts 166 that biases slot nuts 166 away (i.e., outwardly) from one another. Spring member 168 also may be fixedly attached to each slot nut 166 (e.g., as was the case for the embodiment illustrated in FIG. 10), although this is not required. Each slot nut 166 may also define a threaded opening 170 therein that is sized to a threaded fastener 172, such as a bolt or screw. The arrangement is such that spring fastener 140 may be ‘captured’ or retained in position between legs 138 of mounting bracket 136 before mounting bracket 136 is ever secured to receiver 124 of base plate 112. Each spring fastener 140 may be positioned between legs 138 of mounting bracket 136 by pushing together slot nuts 166, compressing spring 168. When released, spring 168 extends slot nuts 166 outwardly, causing them to ‘snap’ into position and engage slots 174 defined by legs 138 of mounting bracket 136. The engagement of slot nuts 166 in slots 174 will serve to retain spring fastener assembly 140 in position within mounting bracket 136.

After spring fasteners 140 have been positioned or secured between legs 138 of mounting bracket 136, mounting bracket 136 may be positioned between flanges 126 on base plate 112 by slightly depressing or pushing together slot nuts 166 to allow them to slide between flanges 126. Once properly aligned with slots 142, spring 168 will cause slot nuts 166 to ‘snap’ into position or engage slots 142 of flanges 126. At this point, spring nuts 140 are regarded as being in the loosened position (i.e., even though threaded fasteners 172 may not be threaded into slot nuts 166) and will allow mounting bracket 136 to be moved along the height 128 of receiver 124. Once mounting bracket 136 has been moved to the desired vertical position (i.e., along height 128), it may be secured by inserting and tightening threaded fasteners 172 into threaded openings 170 of slot nuts 166.

The provision of spring nuts 140 therefore allows for the relatively speedy and simple connection of mounting bracket 136 to flanges 126 and without requiring threaded fasteners 172 to be threaded into slot nuts 166. That is, provided that spring nuts 140 have already been secured in position between legs 138 of mounting bracket 136, a user may easily, rapidly, and simply, position mounting bracket 136 within cavity 130 defined between flanges 126 by compressing spring nuts 140, then allowing them to ‘snap’ into position within slots 142 of flanges 126. Thereafter (i.e., after mounting bracket 136 has been moved to the desired position), mounting bracket 136 may be easily secured to flanges 126 of receiver 124 by inserting and tightening threaded fasteners 172 in slot nuts 166.

Still other embodiments and variations of mounting system according to the disclosed instrumentalities are possible. For example, and with reference now to FIG. 12, another embodiment 210 of mounting system may be similar to embodiments 10 and 110, except that flanges 226 defining receiver 224 may be shorter to produce low-profile mounting system 210. Base plate 212 of low-profile mounting system 210 may have a rectangular or square planform, as shown in FIG. 12. In addition, mounting system 210 may be provided with a bracket 288 for receiving a snow retention bar (not shown). Bracket 288 may be sized to be received between flanges 226 defining receiver 224 of base plate 212. Bracket 288 may define one or more circular openings 290 therein sized to receive the snow retention bar. Bracket 288 may be sized to be received between mounting bracket (such as mounting brackets 36 and 136) and flanges 226. Alternatively, bracket 288 may be used by itself, i.e., without the presence of a mounting bracket. Bracket 288 may also define one or more slots 292 therein (e.g., akin to slots 74, 174 defined by legs 38, 138 of mounting bracket 36, 136) sized to receive spring fasteners, such as spring fasteners 40 or 140, to allow bracket 288 to be mounted, either alone or in conjunction with a mounting bracket, to flanges 226 in the manner already described for embodiments 10 and 110.

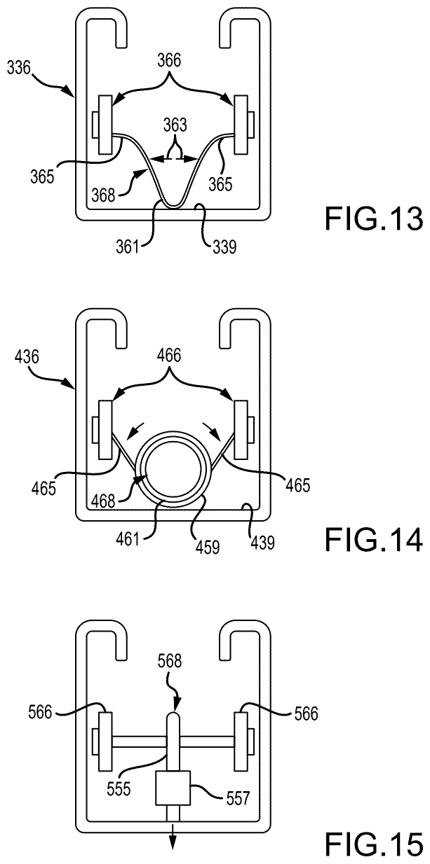

Other variations of the spring fastener assemblies 40, 140 are possible. For example, in another embodiment, illustrated in FIG. 13, spring member 368 may comprise a coil-less or V-shaped spring to provide an outwardly-directed pressure or bias to nuts 366, as indicated by arrows 363. In such an embodiment, the ends 365 of the coil-less or V-shaped spring member 368 may be configured to contact the nuts 360. The apex 361 of V-shaped spring member 368 may be configured to contact the bottom portion 339 of mounting bracket 336.

In still another embodiment, illustrated in FIG. 14, spring member 468 may comprise a coiled spring having one or more circular winds or coils 459, such that the ends 465 of the coiled spring member 468 contact nuts 466. A bottom portion 461 of coils 459 may contact the bottom portion 439 of the mounting bracket 436. In yet a further embodiment, illustrated in FIG. 15, spring member 568 may comprise a sleeve 557 and plunger 555 spring assembly.

Unless defined otherwise, all technical and scientific terms used herein have the same meaning as commonly understood by persons having ordinary skill in the art to which the invention pertains. Although any methods and materials similar or equivalent to those described herein can be used in practice for testing of the present invention, the preferred materials and methods are described herein.

In understanding the scope of the present invention, the articles “a” and “an” are used herein to refer to one or to more than one (i.e., to at least one) of the grammatical object of the article. By way of example, “an element” means one element or more than one element. The term “comprising” and its derivatives, as used herein, are intended to be open ended terms that specify the presence of the stated features, elements, components, groups, and/or steps, but do not exclude the presence of other unstated features, elements, components, groups, and/or steps. The foregoing also applies to words having similar meanings such as the terms, “including,” “having” and their derivatives. Any terms of degree such as “substantially,” “about” and “approximate” as used herein mean a reasonable amount of deviation of the modified term such that the end result is not significantly changed. When referring to a measurable value, such as an amount, a temporal duration, and the like, these terms are meant to encompass variations of at least ±20% or ±10%, more preferably ±5%, even more preferably ±1%, and still more preferably ±0.1% from the specified value, as such variations are appropriate and as would be understood by persons having ordinary skill in the art to which the invention pertains.

Throughout this disclosure, various aspects of the invention may be presented in a range format. It should be understood that the description in a range format is merely for convenience and brevity and should not be construed as an inflexible limitation on the scope of the invention. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 2.6, 3, 4, 5, 5.7, and 6. This applies regardless of the breadth of the range.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adapted to another embodiment. It should be noted that while the present invention is shown and described herein as it could be used in conjunction with a configuration of various components, it could be utilized with other configurations, either now known in the art or that may be developed in the future, so long as the objects and features of the invention are achieved, as would become apparent to persons having ordinary skill in the art after having become familiar with the teachings provided herein. Consequently, the present invention should not be regarded as limited to that shown and described herein. It is not necessary for all advantages to be present in a particular embodiment at the same time. Thus, the foregoing descriptions of the embodiments according to the present invention are provided for illustration only, and not for the purpose of limiting the invention as defined by the appended claims and their equivalents.

Having herein set forth preferred embodiments of the present invention, it is anticipated that suitable modifications can be made thereto which will nonetheless remain within the scope of the invention. The invention shall therefore only be construed in accordance with the following claims:

1. A mounting system, comprising:
a base plate defining a top surface and a bottom surface, said base plate defining a plurality of mounting holes therein;
a receiver mounted to said base plate, said receiver comprising at least a first sidewall and a second sidewall extending upwardly from said base plate in generally parallel, spaced-apart relation so that an interior cavity is defined therebetween, each of the first and second sidewalls defining at least one fastener opening therein;
a mounting bracket comprising a bottom portion and first and second leg portions extending from the bottom portion in generally parallel-spaced apart relation so that a channel is defined therebetween, each of said first and second leg portions defining at least one fastener opening therein, said mounting bracket being sized to be received by the interior cavity defined by said receiver; and
a spring fastener assembly operably engagable with the fastener openings defined by the first and second sidewalls of said receiver and the first and second leg portions of said mounting bracket when the fastener openings of said receiver and mounting bracket are substantially aligned, said spring fastener assembly securing said mounting bracket to said receiver.

2. The mounting system of claim 1, wherein said spring fastener assembly further comprises:
a first nut;
a second nut;
a spring member positioned between said first and second nuts, said spring member biasing said first and second nuts away from one another;
a first fastener operably engagable with the first nut; and
a second fastener operably engagable with the second nut.

3. The mounting system of claim 2, wherein said spring member is attached to each of said first and second nuts.

4. The mounting system of claim 2, wherein the first and second nuts comprise threaded openings therein, wherein the first and second fasteners comprise threaded fasteners, and wherein the first and second nuts comprise generally rectangularly-shaped members having lengths that are greater than a distance between the fastener opening defined by the leg portions of said mounting bracket and the bottom portion of said mounting bracket so that the rectangularly-shaped first and second nuts will contact the bottom portion of said mounting bracket when the first and second threaded fasteners are threaded into the first and second nuts, the contact between the first and second nuts and the bottom portion of said mounting bracket preventing rotation of the first and second nuts.

5. The mounting system of claim 4, wherein end portions of the rectangularly-shaped first and second nuts define respective beveled portions, the beveled portions of the respective first and second nuts contacting the bottom portion of said mounting bracket to prevent rotation of the first and second nuts.

6. The mounting system of claim 2, wherein the first and second nuts comprise threaded openings therein, wherein the first and second fasteners comprise threaded fasteners, wherein the fastener openings defined by the first and second legs of said mounting bracket define slots, and wherein the first and second nuts comprise respective bosses sized to engage the slots defined by the first and second legs of said mounting bracket so that the first and second nuts are prevented from rotating when the respective bosses are engaged with the slots.

7. The mounting system of claim 1, further comprising a sealing membrane, said sealing membrane defining an outer periphery and a central aperture therein sized so that when said sealing membrane is positioned over the top surface of said base plate the central aperture of said sealing membrane closely receives said receiver and so that the outer periphery of said sealing membrane extends beyond the plurality of mounting holes defined by said base plate.

8. The mounting system of claim 7, wherein said sealing membrane comprises an elastomeric material having an adhesive provided on a bottom surface thereof, said adhesive sealingly engaging the elastomeric material comprising said sealing membrane to the substrate.

9. The mounting system of claim 7, wherein said sealing membrane comprises a liquid membrane system.

10. The mounting system of claim 1, wherein when said spring fastener assembly is in a loosened position said mounting bracket is movable in at least one direction with respect to said receiver and so that when said spring fastener assembly is in a tightened position said mounting bracket is not movable in the at least one direction with respect to said receiver.

11. The mounting system of claim 1, wherein said base plate and said receiver are formed from a single piece of material.

12. The mounting system of claim 1, wherein said base plate and said receiver are formed from separate pieces of material that are then fastened together.

13. The mounting system of claim 1, wherein said base plate and said receiver comprise one or more selected from the group consisting of metals and metal alloys.

14. The mounting system of claim 1, wherein said base plate and said receiver comprise one or more selected from the group consisting of polymers and reinforced polymers.

15. A method of mounting equipment to a support structure, comprising:
providing a mounting system, the mounting system comprising:
a base plate having a top surface and a bottom surface, the base plate defining a plurality of mounting holes therein;
a receiver mounted to the base plate, the receiver comprising at least a first sidewall and a second sidewall extending upwardly from said base plate in generally parallel, spaced-apart relation so that an interior cavity is defined therebetween, each of the first and second sidewalls defining at least one fastener opening therein;
a mounting bracket comprising a bottom portion and first and second leg portions extending from the bottom portion in generally parallel-spaced apart relation so that a channel is defined therebetween, each of the first and second leg portions defining at least one fastener opening therein, the mounting bracket being sized to be received by the interior cavity defined by the receiver; and
a spring fastener assembly operably engagable with the fastener openings defined by the first and second sidewalls of the receiver and the first and second leg portions of the mounting bracket when the fastener openings of the receiver and the mounting bracket are substantially aligned;
providing a sealing membrane, the sealing membrane defining a central aperture therein sized to receive the receiver and an outer periphery that extends beyond the plurality of mounting holes defined by the base plate;
mounting the base plate to the support structure with a plurality of mounting fasteners, each of the plurality of mounting fasteners engaging corresponding ones of the plurality of holes defined by the base plate and the support structure;
positioning the sealing membrane over the top surface of said the plate;
sealingly engaging the outer periphery of the sealing membrane to the support structure;
positioning the mounting bracket within the interior cavity defined by the receiver;
engaging the spring fastener assembly loosely with the receiver and the mounting bracket so that the mounting bracket is moveable with respect to the receiver;
securing the mounting bracket to at least a portion of the equipment; and
tightening the spring fastener assembly so that the mounting bracket is not moveable with respect to said mounting system.

16. A mounting system, comprising:
a base plate having a top surface and a bottom surface, said base plate defining a plurality of mounting holes therein;
a receiver mounted to said base plate, said receiver comprising first and second flange members positioned in generally parallel, spaced-apart relation and extending generally upwardly from the top surface of said base plate so that an interior cavity is defined therebetween, the interior cavity of said receiver sized to receive a mounting bracket for mounting a piece of equipment to said mounting system, the mounting bracket defining at least one fastener opening therein, each of the first and second flange members defining at least one elongate slot therein; and
a spring fastener assembly operably engagable with the fastener opening defined by the mounting bracket and the fastener openings defined by the first and second flange members.

17. The mounting system of claim 16, wherein said spring fastener assembly further comprises:
a first nut defining an opening therein;
a second nut defining an opening therein;
a spring provided between said first and second nuts, said spring biasing said first and second nuts away from one another;
a first fastener operably engagable with the opening defined by said first nut; and
a second fastener operably engagable with the opening defined by said second nut.

18. The mounting system of claim 17, wherein the openings defined by said first and second nuts are threaded, and wherein said first and second fasteners comprise threaded fasteners.

19. The mounting system of claim 18, wherein the threaded fasteners comprise one or more selected from the group consisting of bolts and screws.

20. The mounting system of claim 17, wherein said spring member is fixedly attached to each of said first and second nuts.

21. The mounting system of claim 17, wherein said spring member comprises one or more selected from the group consisting of coil springs, coil-less springs, coiled torsion springs, and a sleeve and plunger.

22. The mounting system of claim 16, further comprising a sealing membrane, said sealing membrane defining an outer periphery and a central aperture therein sized so that when said sealing membrane is positioned over the top surface of said base plate the central aperture of said sealing membrane closely receives said receiver and so that the outer periphery of said sealing membrane extends beyond the plurality of mounting holes defined by said base plate.

23. The mounting system of claim 22, wherein said sealing membrane comprises an elastomeric material having an adhesive provided on a bottom surface thereof, said adhesive sealingly engaging the elastomeric material comprising said sealing membrane to the substrate.

24. The mounting system of claim 22, wherein said sealing membrane comprises a liquid membrane system.

25. The mounting system of claim 16, further comprising a bar retention bracket having first and second leg portions joined together by a bottom portion, the first and second leg portions defining openings therein that are sized to receive a retention bar, the first and second leg portions also defining fastener openings therein, said bar retention bracket sized to be received by the interior cavity defined by said receiver at a position between the first and second flanges and the mounting bracket.

26. A method of mounting equipment to a support structure, comprising:
providing a mounting system, said mounting system comprising:
a base plate having a top surface and a bottom surface, said base plate defining a plurality of mounting holes therein; and
a receiver mounted to the base plate, the receiver comprising first and second flange members positioned in generally parallel, spaced-apart relation and extending generally upwardly from the top surface of the base plate so that an interior cavity is defined therebetween, each of the first and second flange members defining at least one fastener opening therein;
providing a mounting bracket sized to be received by the interior cavity defined by the receiver, the mounting bracket defining at least one fastener opening therein;
providing a spring fastener assembly operably engagable with the fastener opening defined by the mounting bracket and the at least one fastener opening defined by the first and second flange members;
providing sealing membrane, the sealing membrane defining a central aperture therein sized to receive the receiver and an outer periphery that extends beyond the plurality of mounting holes defined by the base plate;
mounting the base plate to the support structure with a plurality of mounting fasteners, each of the plurality of mounting fasteners engaging corresponding ones of the plurality of holes defined by the base plate and the support structure;
positioning the sealing membrane over the top surface of the base plate;
sealingly engaging the outer periphery of the sealing membrane to the support structure;
positioning the mounting bracket within the interior cavity defined by the receiver;
engaging the spring fastener assembly loosely with the receiver and the mounting bracket so that the mounting bracket is moveable with respect to the receiver;
securing the mounting bracket to at least a portion of the equipment; and
tightening the spring fastener assembly so that the mounting bracket is not moveable with respect to said mounting system.

27. The method of claim 26, further comprising:
providing a bar retention bracket, the bar retention bracket having first and second leg portions joined together by a bottom portion, the first and second leg portions defining fastener openings therein, the first and second leg portions also defining openings therein that are sized to receive a retention bar; and
positioning the bar retention bracket within the interior cavity defined by the receiver before positioning the mounting bracket within the interior cavity, then positioning the mounting bracket between the first and second leg portions of the bar retention bracket so that the bar retention bracket is captured between the mounting bracket and the first and second flanges.

28. The method of claim 27, further comprising positioning a retention bar within the retention bar openings defined by the first and second leg portions of the bar retention bracket.
